(19) United States
(12) Patent Application Publication
(10) Pub. No.: US 2007/0178924 A1
(43) Pub. Date: Aug. 2, 2007

(54) Apparatus for notifying a mobile user of a push-to-talk communication call in a mobile communication system and method therefor

(75) Inventor: Seong-Hun Kang, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/448,673

(22) Filed: Jun. 8, 2006

(30) Foreign Application Priority Data
Jan. 13, 2006 (KR) 2006-3951

(51) Int. Cl. H04B 7/00; H04Q 7/20

(52) U.S. Cl. 455/518

(57) ABSTRACT

A method and apparatus for notifying a mobile user of a push-to-talk (PTT) communication call signal in a mobile communication system are provided in which a caller's mobile terminal transmits the PTT communication call signal, including identifying information of a receiver's mobile terminal, through a PTT server to a receiver's mobile terminal, and the receiver's mobile terminal notifies the receiver of reception of the PTT communication call signal by means of a PTT communication start sound set by the receiver.

### CROSS-REFERENCE TO RELATED APPLICATIONS

This application claims the benefit under 35 U.S.C. § 119(a) of a Korean Patent Application filed with the Korean Intellectual Property Office on Jan. 13, 2006 and assigned Serial No. 2006-3951, the entire disclosure of which is hereby incorporated by reference.

### BACKGROUND OF THE INVENTION

1. Field of the Invention

The present invention relates to a mobile communication system involving push-to-talk (PTT) communication. More particularly, the present invention relates to a method for notifying a mobile user of a PTT communication call signal in such mobile communication system.

2. Description of the Related Art

PTT is an acronymic term used for representing the basic communication feature of a radio transceiver such as walkie-talkie or Trunked Radio System (TRS), which is provided with a PTT button to press or release for performing communication with a distant party. Namely, the user presses the PTT button to speak to a distant party or releases it to listen to the distant party. Such PTT communication makes it possible to readily and immediately establish a communication connection between one person and another distant party.

The mobile communication system employing such PTT communication feature enables the user of a mobile communication terminal to exchange both voices and data with a distant party. For example, if the user presses the PTT button provided in the mobile communication terminal, the mobile terminal sends a call signal for requesting a PTT communication service through the mobile communication network to establish a communication connection with a distant party. Meanwhile, at the receiving end, the mobile terminal called notifies the receiver of reception of the call signal by means of producing a sound or displaying a message. Once the reception of the PTT communication call is recognized, the receiver starts PTT communication with the caller. Thus, the distant party at the receiving end can hear the voices transmitted from the caller.

In such mobile communication system providing the PTT services, the PTT mobile communication terminal of the receiver produces a sound to notify the reception of the PTT communication call signal together with the identifying information of the caller, and the PTT mobile communication terminal of the caller produces a sound to notify the reception of a PTT communication acknowledgment signal from the receiver together with the identifying information of the receiver. Conventionally, such notifying sounds of the caller's and receiver's PTT mobile terminals are respectively attached to the PTT communication call signal and PTT communication acknowledgment signal through a PTT server that serves to mediate the communication connection between the caller's and the receiver's mobile terminal. Namely, the notifying sounds are fixedly determined and attached by the PTT server to the PTT communication call and acknowledgment signals. Accordingly the user experiences difficulties in distinguishing the fixedly determined notifying sound. Moreover, since the fixedly determined notifying sound consists of a high frequency, the user employing a hands-free device such as an earphone may be adversely affected by the high frequency notifying sound in the ear.

Accordingly, there is a need for an improved apparatus and method for setting a communication start sound of a push-to-talk communication call for a caller's mobile terminal and receiver's mobile terminal.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a method for assisting the mobile user at the receiving end to make a response to a PTT communication call signal from the caller in a mobile communication system.

It is another object of exemplary embodiments of the present invention to provide a method for immediately notifying the mobile user at the receiving end of the identifying information of the PTT communication caller in a mobile communication system.

According to an aspect of exemplary embodiments of the present invention, there is provided a method for notifying a mobile user of a PTT communication call signal in a mobile communication system, in which a caller's mobile terminal transmits the PTT communication call signal including the identifying information of a receiver's mobile terminal through a PTT server to the receiver's mobile terminal, and the receiver's mobile terminal notifies the receiver of the reception of the PTT communication call signal by means of a PTT communication start sound set by the receiver.

According to another aspect of exemplary embodiments of the present invention, there is provided an apparatus for notifying a mobile user of a PTT communication call signal in a mobile communication system, in which a caller's mobile terminal sends the PTT communication call signal to at least one receiver's mobile terminal by inputting a predetermined key, the caller's mobile terminal produces a PTT communication start sound set by the caller to notify the caller of reception of a PTT communication acknowledgment signal in response to the PTT communication call signal and to establish a PTT communication with the receiver's mobile terminal, the receiver's mobile terminal produces a PTT communication start sound set by the receiver to notify the receiver of reception of the PTT communication call signal from the caller's mobile terminal and to establish the PTT communication with the caller's mobile terminal, and a PTT server receives the PTT communication call signal to send the identifying information of at least one receiver's mobile terminal to the caller's mobile terminal and to transfer the PTT communication call signal to the receiver's mobile terminal selected by the caller's mobile terminal, the PTT server receiving the PTT communication acknowledgment signal from the receiver's mobile terminal to transfer the PTT communication acknowledgment signal to the caller's mobile terminal, and the PTT server making the PTT communication connection between the caller's mobile terminal and the receiver's mobile terminal.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF DRAWINGS

The above and other objects, features, and advantages of certain exemplary embodiments of the present invention will be more apparent from the following description taken in conjunction with the accompanying drawings, in which:

FIG. 1 is a schematic diagram for illustrating a mobile communication system providing PTT services according to an exemplary embodiment of the present invention;

FIG. 2A is a block diagram for illustrating the structure of a mobile communication terminal used according to an exemplary embodiment of the present invention;

FIG. 2B is a schematic view of a mobile communication terminal used according to an exemplary embodiment of the present invention;

FIG. 3 is a flow chart for illustrating a process of setting a PTT communication start sound according to an exemplary embodiment of the present invention;

FIG. 4 is a flow chart for illustrating a process of establishing a PTT communication connection according to an exemplary embodiment of the present invention; and

FIG. 5 a flow chart for illustrating a process of producing a PTT communication start sound according to an exemplary embodiment of the present invention.

Throughout the drawings, the same reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

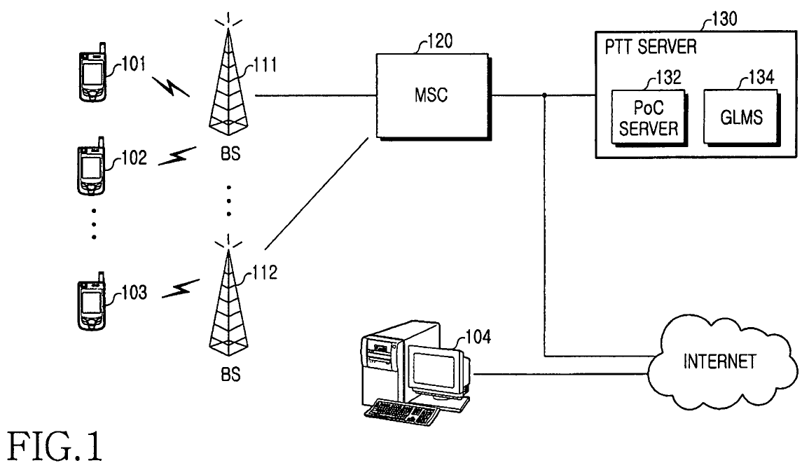

FIG. 1 illustrates a mobile communication system providing PTT communication services, which includes a plurality of base station transceiver systems 111, 112 providing mobile communication systems 101, 102, 103 with mobile communication services. The base station transceiver systems 111, 112 are connected with a mobile switching center (MSC) 120, which in turn is connected through a data network to a PTT server 130.

The PTT server 130 controls all PTT user groups in real time, performing the functions of mediating a PTT communication call, distributing the registry list of subscribers, and establishing and separating calls of required systems and network resources. The PTT server 130 includes a PTT over Cellular (PoC) server unit 132 for providing PTT communications services through mobile communication networks and Group and List Management Server (GLMS) unit 134 for managing PTT subscribers' information, buddy list recording groups of subscribers, and the like.

Each of the mobile communication terminals 101, 102, 103 is provided with a PTT module for performing PTT related functions, sending a PTT communication call signal properly formatted to the base station transceiver system 111, 112. The MSC 120 is provided with Inter-Working Function (IWF) to switch data packets including the PTT communication call signal received from the mobile communication terminal 101, 102, 103 between the base station transceiver system 111, 112 and the PTT server 130.

Meanwhile, the user connects the mobile terminal 101, 102, 103 with the PTT server 130 to revise the user's information and group list information prepared by the user, such as adding, altering, and deleting. The revision may be performed by means of a personal computer 104 connected through the Internet to the PTT server 130.

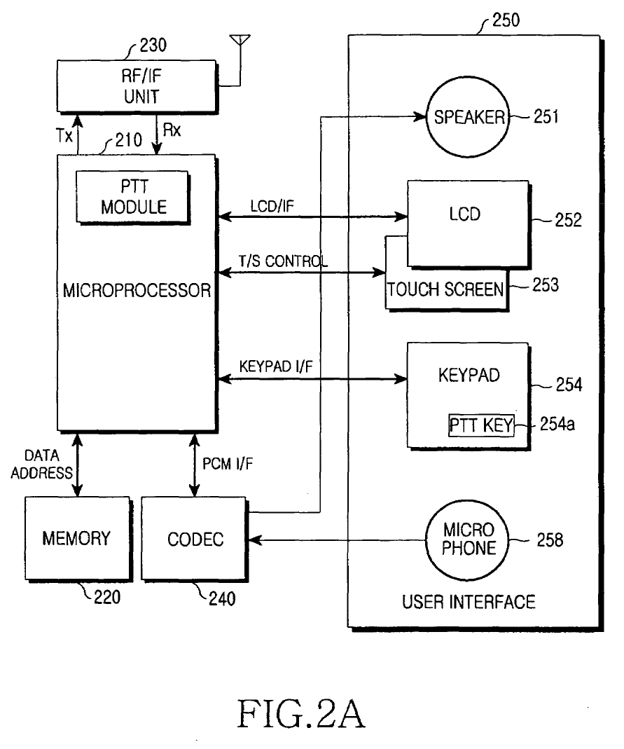

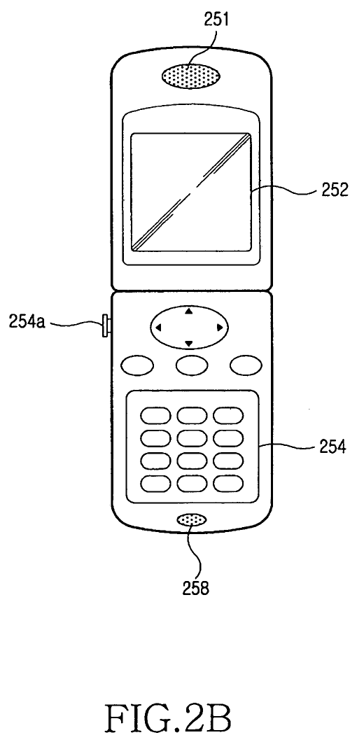

Referring to FIGS. 2A and 2B, the mobile terminal according to an exemplary embodiment of the present invention includes a user interface 250, radio frequency/intermediate frequency (RF/IF) unit 230, memory 220, and microprocessor 210 connected with codec 240.

The user interface 250 includes a microphone 258 for converting the user's voice into an electrical signal delivered to a voice signal processor (codec 240), a speaker 251 for converting the electrical voice signal received from the codec 240 into an audible sound, keypad 254 having a plurality of numeric/character keys and function keys for performing mobile communication functions, and an exclusive PTT key 254a for performing the PTT communication function. The key input data entered by the user is delivered to the microprocessor 210. FIG. 2A shows the PTT key 254a separately provided, but one of the conventional function keys may be used as the PTT key.

The user interface also includes a display unit 252 composed of an LCD controller, memory for video data, and LCD element, which is controlled by the microprocessor 210 to display the present state of the mobile terminal, user menu information, background image, and the like. The LCD element of the display unit 252 may be provided with a touch screen 253.

The memory 220 stores an address information book entered by the user, which contains names and phone numbers of acquaintances and the like. The user's buddy list may be stored into the address information book.

The RF/IF unit 230 comprises an RF transmitter for upward transforming and amplifying a transmitted signal, and an RF receiver for downward transforming and low-noise amplifying a received signal, transforming the modulated signal from the microprocessor 210 sequentially into an IF signal and then a high frequency (RF) signal transmitted through the antenna to the base station transceiver system, and transforming the RF signal received from the base station transceiver system sequentially into an IF signal and then a base band signal delivered to the microprocessor 210.

The voice signal processor 240 generally consisting of a audio codec converts an analog voice signal received from the microphone 258 into a digital signal (PCM signal) delivered to the microprocessor 210, and a digital signal received from the microprocessor 210 into an analog signal delivered to the speaker 251. The voice signal processor 240 is shown by a separate block in FIG. 2A, but may be contained in the microprocessor 210.

The microprocessor 210 performs various functions of the mobile terminal according to the key data input from the keypad 254, and controls the display unit 252 to display the information concerning the present state of the mobile terminal, user menu, and the like. When processing the voice signals for telephoning, the microprocessor converts the PCM voice signals received from the voice signal processor 240 through channel coding and interleaving, and modulate the converted signal applied to the RF/IF unit 230, while demodulating, equalizing, channel-coding, and deinterleaving the voice signals from the RF/IF unit 230 to produce the PCM voice signals -applied to the voice signal processor 240. In addition, the microprocessor 210 is provided with a PTT module for performing PTT communication services according to an exemplary embodiment of the present invention, enabling the user to communicate with a particular person during a PTT group communication.

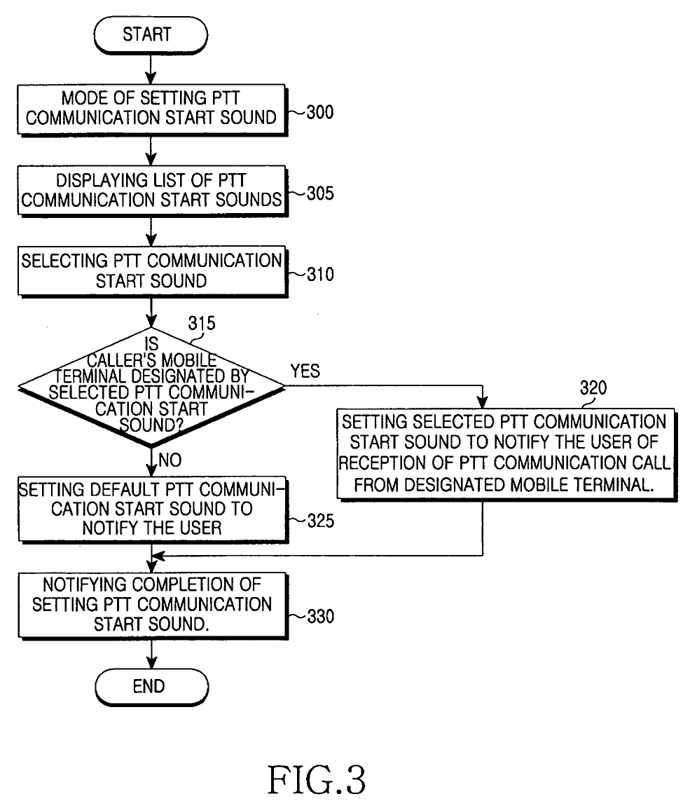

Describing the process of setting a PTT communication start sound in connection with FIG. 3, the microprocessor 210 executes step 300 to set the PTT communication start sound for the user's PTT communication. Then the microprocessor 210 goes to step 305 to display a list of PTT communication start sounds stored in the memory 220 for notifying the user of reception of a call or message. In step 310, the microprocessor 210 selects one of the start sounds according to the user's command. Accordingly, when the user's mobile terminal receives a PTT communication call signal from another mobile terminal, the microprocessor 210 executes step 315 to determine whether the caller's mobile terminal has been designated by a selected PTT communication start sound.

If the caller's mobile terminal has not been designated by a selected PTT communication start sound in step 310, the microprocessor 210 goes to step 325 to set a default PTT communication start sound for designating the caller's mobile terminal instead of a selected PTT communication start sound. On the contrary, if the caller's mobile terminal has been designated by a selected PTT communication start sound, the microprocessor 210 goes to step 320 to set the selected PTT communication start sound for notifying the user. After completion of setting the PTT communication start sound, the microprocessor 210 executes step 330 to produce the PTT communication start sound together with a message for notifying the storage thereof.

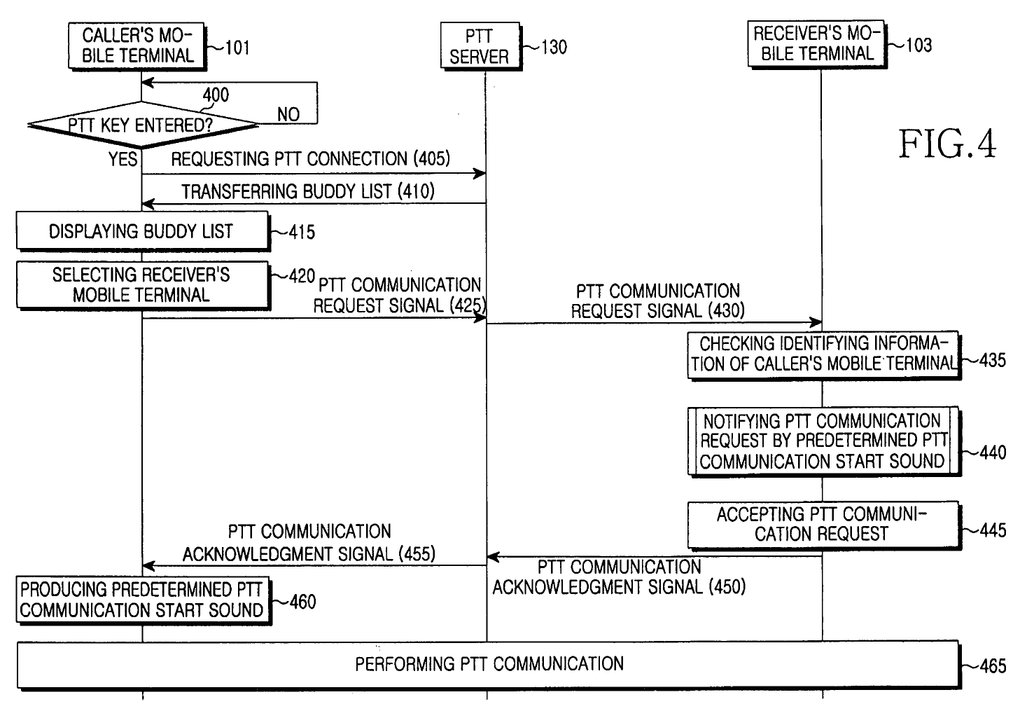

Describing the flow of the PTT communication operations in connection with FIG. 4, the caller's mobile terminal 101 executes step 400 to determine whether the PTT key is entered or a menu selection signal is generated for performing PTT communication. When the PTT key 254a is entered, the caller's mobile terminal sends a PTT connection request signal to the PTT server 130 in step 405. Then the PTT server 130 transfers a previously registered buddy list to the caller's mobile terminal 101 in step 410. Then the caller's mobile terminal 101 causes the display unit to display the received buddy list in step 415. Subsequently, the user selects at least one of the receiver's mobile terminals from the displayed buddy list by operating a directional key in step 420. In an exemplary implementation, one receiver's mobile terminal 103 is selected.

Thereafter, the caller's mobile terminal 101 sends a PTT communication request signal to the PTT server 130 to invite the receiver's mobile terminal 103 in step 425. Then the PTT server 130 transfers the PTT communication request signal to the receiver's mobile terminal 103 in step 430. Once the PTT communication request signal is received from the caller's mobile terminal, the receiver's mobile terminal 103 checks the identifying information of the caller's mobile terminal in step 435, and generates a predetermined PTT communication start sound for notifying the user of the PTT communication request from the caller's mobile terminal in step 440.

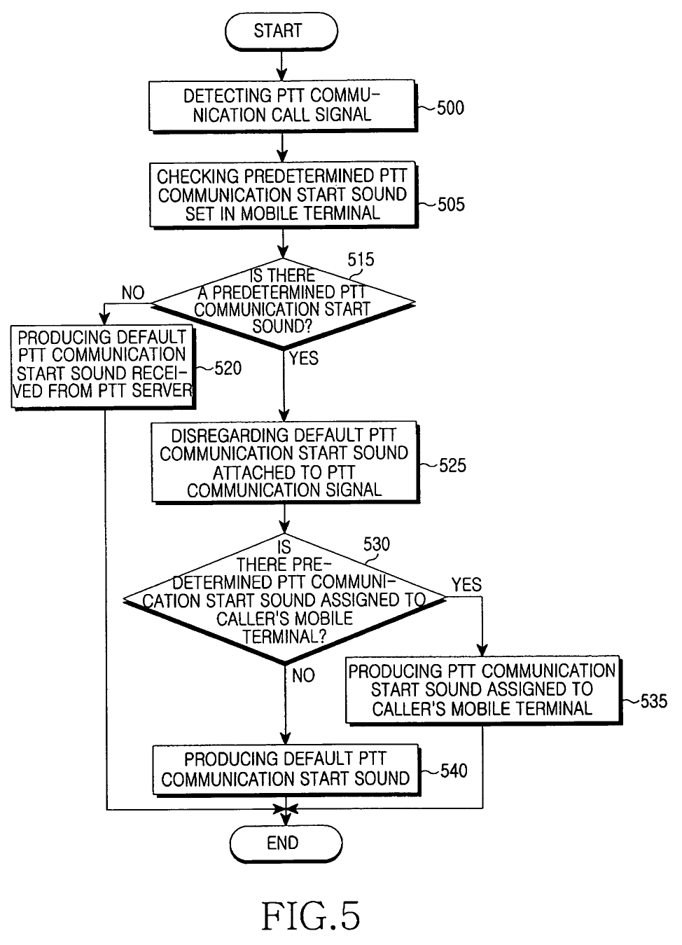

Then the receiver's mobile terminal generates a PTT communication acknowledgment signal in step 445, transferred to the PTT server 130 in step 450. The PTT server 130 transfers the PTT communication acknowledgment signal to the caller's mobile terminal 101 in step 455. Then the caller's mobile terminal 101 produces a predetermined PTT communication start sound to notify the caller of the reception of the PTT communication acknowledgment signal from the PTT server 130 in step 460. The steps of producing the PTT communication start sound in the caller's and the receiver's mobile terminal will be described in detail with reference to FIG. 5. When receiving the PTT communication acknowledgment signal, the caller's mobile terminal 101 establishes the PTT communication connection with the receiver's mobile terminal 103 to perform PTT communication in step 465.

In describing the steps of outputting the PTT communication start sound in connection with FIG. 5, the receiver's mobile terminal 103 detects a PTT communication call or request signal from the caller's mobile terminal 101 in step 500. Then the receiver's mobile terminal 103 checks in step 505 a predetermined PTT communication start sound to notify the PTT communication call signal received from the caller's mobile terminal 101. The receiver's mobile terminal 103 determines in step 515 whether the caller's mobile terminal 101 is designated by a predetermined PTT communication start sound. If there is no predetermined PTT communication start signal for the caller's mobile terminal, the receiver's mobile terminal 103 causes the default PTT communication start sound attached to the PTT communication call signal received from the PTT server 130 to be produced in step 520. The default PTT communication start sound is similar to the conventional start sound. In an exemplary implementation, if there is no predetermined PTT communication start signal for the caller's mobile terminal, the receiver's mobile terminal 103 causes the default PTT communication start sound to be produced.

On the contrary, if there is a predetermined PTT start sound in step 515, the receiver's mobile terminal 103 disregards the default PTT communication start sound attached in step 525. For example, the PTT communication call signal received from the PTT server 130 may contain a command for blocking the default PTT communication start sound if the receiver's mobile terminal detects a predetermined PTT communication start sound set therein.

Then, according to a checked result of step 435 as shown in FIG. 4, the receiver's mobile terminal 103 determines in step 530 whether the caller's mobile terminal is designated by a predetermined PTT communication start sound to notify the receiver of the reception of the PTT communication call signal from the caller's mobile terminal. If a predetermined PTT communication start sound designating the caller's mobile terminal 101 exists, the receiver's mobile terminal 103 produces in step 535 the predetermined PTT communication start sound to notify the reception of the PTT communication call signal from the caller's mobile terminal.

On the contrary, if in step 530 a predetermined PTT communication start sound designating the caller's mobile terminal 101 does not exist, the receiver's mobile terminal 101 produces in step 540 the default PTT communication start sound to notify the reception of the PTT communication call signal.

Although the above description in connection with FIG. 5 shows the steps of the receiver's mobile terminal 103 to produce the PTT communication start sound in response to the PTT communication call signal, similar steps are applied to the caller's mobile terminal 101 to produce the PTT communication start sound to notify the caller of the reception of the PTT communication acknowledgment signal from the receiver's mobile terminal.

Thus, according to the inventive PTT communication method in a mobile communication system, the mobile terminal can produce a PTT communication start sound predetermined by the user to notify the reception of a PTT communication call signal. Although certain exemplary embodiments of the present describes the inventive PTT communication method between a single caller's and a single receiver's mobile terminal, a plurality of mobile terminals may be designated as a receiver group to perform a similar PTT communication method with a caller's mobile phone.

While the present invention has been shown and described with reference to certain exemplary embodiments thereof, it will be understood by those skilled in the art that various changes in form and details may be made therein without departing the spirit and scope of the present invention as defined by the appended claims and their equivalents.

What is claimed is:

1. A method for notifying a mobile user of a push-to-talk (PTT) communication call signal in a mobile communication system, comprising:
transmitting from a caller's mobile terminal said PTT communication call signal, including identifying information of a receiver's mobile terminal, through a PTT server to said receiver's mobile terminal; and
operating said receiver's mobile terminal to notify the receiver of the reception of said PTT communication call signal using a PTT communication start sound set by the receiver.

2. The method as defined in claim 1, further comprising notifying the receiver of the reception of said PTT communication call signal using a communication start sound contained in said PTT communication call signal received from said PTT server, if said receiver's mobile terminal PTT communication start sound is not set by the receiver.

3. The method as defined in claim 1, further comprising:
sending a PTT communication acknowledgment signal from said receiver's mobile terminal in response to said PTT communication call signal through said PTT server to said caller's mobile terminal; and
operating said caller's mobile terminal to notify the caller of reception of said PTT communication acknowledgment signal using a PTT communication start sound set by the caller.

4. The method as defined in claim 1, further comprising:
checking the identifying information of the caller's mobile terminal upon receiving said PTT communication call signal;
determining whether a PTT communication start sound assigned to the caller's mobile terminal exists; and
producing the PTT communication start sound assigned to the caller's mobile terminal if the PTT communication start sound is found.

5. The method as defined in claim 1, further comprising:
checking the identifying information of the receiver's mobile terminal upon receiving a PTT communication acknowledgment signal from the receiver's mobile terminal in response to said PTT communication call signal;
determining whether a PTT communication start sound assigned to the receiver's mobile terminal exists; and
producing the PTT communication start sound assigned to the receiver's mobile terminal if the PTT communication start sound is found.

6. The method as defined in claim 1, wherein if the PTT communication start sound is not set by the receiver, a PTT communication start sound received from said PTT server is produced.

7. An apparatus for notifying a mobile user of a push-to-talk (PTT) communication call signal in a mobile communication system, comprising:
a caller's mobile terminal for sending said PTT communication call signal to at least one receiver's mobile terminal by inputting a key, said caller's mobile terminal producing a PTT communication start sound set by the caller to notify the caller of reception of a PTT communication acknowledgment signal in response to said PTT communication call signal and to establish a PTT communication with the receiver's mobile terminal;
said receiver's mobile terminal producing a PTT communication start sound set by the receiver to notify the receiver of reception of said PTT communication call signal from said caller's mobile terminal and to establish the PTT communication with the caller's mobile terminal; and
a PTT server for receiving said PTT communication call signal to send the identifying information of at least one receiver's mobile terminal to the caller's mobile terminal and to transfer said PTT communication call signal to the receiver's mobile terminal selected by the caller's mobile terminal, said PTT server receiving the PTT communication acknowledgment signal from the receiver's mobile terminal to transfer the PTT communication acknowledgment signal to the caller's mobile terminal, and said PTT server making the PTT communication connection between the caller's mobile terminal and the receiver's mobile terminal.

8. The apparatus as defined in claim 7, wherein said receiver's mobile terminal checks the identifying information of the caller's mobile terminal upon receiving said PTT communication call signal to notify the receiver of reception of said PTT communication call signal by a PTT communication start sound assigned by the receiver to represent the caller's mobile terminal.

9. The apparatus as defined in claim 8, wherein said caller's mobile terminal checks the identifying information of the receiver's mobile terminal upon receiving the PTT communication acknowledgment signal to notify the caller of reception of said PTT communication acknowledgment signal by a PTT communication start sound assigned by the caller to represent the receiver's mobile terminal.
